(19) United States
(12) Patent Application Publication
(10) Pub. No.: US 2011/0114764 A1
(43) Pub. Date: May 19, 2011

(54) ATTACHMENT PIECE FOR CONTROLLED AND DIRECTED EMPTYING OF A SPRAY CAN CONTAINING A LIQUID OR GASEOUS SUBSTANCE

(76) Inventor: Bostjan Berginc, Srpenica (SI)

(21) Appl. No.: 12/736,723

(22) PCT Filed: May 6, 2009
(86) PCT No.: PCT/SI2009/000020

§ 371 Date: Jan. 13, 2011

(30) Foreign Application Priority Data
May 9, 2008 (SI) P-200800117

(51) Int. Cl. B05B 1/00

(52) U.S. Cl. 239/589

(57) ABSTRACT

Attachment piece for controlled and directed emptying of a spray can containing a liquid or gaseous substance, preferably an expandable insulating seal substance, consists of a housing (1) with a rest (2) in the form of an inner ring that snap fits the external circumference of a plug (3) with a valve (4) of a can (5). The internal surface of said housing (1) comprises a thread (7), on which a nozzle (8) is arranged. Said nozzle (8) is designed in a way to co-operate with said thread (7) with its thread section (9) of its cylindrical part (10). Said cylindrical part (10) continues on one side by a concentrically arranged tubular part (11) with said rest (12) tightly fitting the free end of said valve (4) of said can (5), wherein on the external end said nozzle (8) is optionally shaped, preferably in the sense of an outflow section (13) oriented perpendicularly to the axis of said can (5).

### SUBJECT OF INVENTION

The subject of the present invention is an attachment piece for controlled and directed emptying of a spray can containing a liquid or gaseous substance, preferably an expandable insulating seal substance.

### TECHNICAL PROBLEM

The technical problem solved by the present invention is how to construct such attachment piece for a spray can that would allow a liquid or gaseous substance to flow out, wherein the flow should be repeatable until the can gets completely empty, without the flowing substance to partly escape by the valve during application in an uncontrolled way. The attachment piece should also allow the can to be positioned on a spray gun for controlled flowing out of the content.

### PRIOR ART

Known attachment pieces of this type are intended to be arranged directly on the nozzle of a can valve. The opening of the valve and subsequent partly controlled and directed flowing out of the content is performed simply by a finger pressure (thumb or index finger) in axial direction on the attachment piece. A disadvantage of said solution is in that it is very difficult to achieve a permanent and unchanged pressure on the valve during long term flowing out of the content due to a need for a constant quantity of the applicable substance. This is a necessary condition during the installation of builder's carpentry and joinery, for instance of windows into walls. A changed pressure on the valve changes the quantity of the applied substance, which has a negative effect on the speed and quality of work. It is even less adequate if the flow of the content is discontinued during the application. Another disadvantage lies in that it is very difficult to persist in an actual axially parallel pressure on the valve with a finger. If non-axial pressure is exerted on the valve, the content may escape the can at the valve or outlet nozzle, which is extremely undesirable due to the contamination of the environment and consumption of the content as scrap.

Another problem encountered both by manufacturers of sprays and users is that spray cans intended for manual spraying are provided with one valve type, whereas spray cans intended for spray guns dispose over a different valve and an additional attachment piece near the valve, onto which the spray gun is screwed. The manufacturers and users thus need two different products that cannot be mutually interchanged during use. Two types of spray cause logistic problems and an increase in price of the product and services rendered by the use thereof.

Application of a spray gun is preferred over spraying of the content manually and directly through the valve in that it allows for a better directing of the content and less tiring holding of the valve in open position. However, a disadvantage of the spray gun lies in that it needs to be carefully cleaned after each application. Application of a spray without a spray gun is tiring, as described above, yet does not require any cleaning after each application.

There is a need for such new technical solution that would bring about a unification of the area around the spray valve, so that the same spray will be applicable both for manual work without problems as mentioned above and for a spray gun. Since a spray can is often used for a unique application until its full emptying, an attachment piece that would compensate for the advantages of a spray gun would do away with a need for cleaning, since the price of the attachment piece justifies a disposable piece.

### SOLUTION TO THE TECHNICAL PROBLEM

The described technical problem is solved by the attachment piece of the invention. It is characterised in that it consists of a housing that can be arranged, preferably upon the production of a spray, onto a circumference at the can valve, and of a nozzle screwed in said housing and positioned in a way to tightly fit the nozzle of the can valve, wherein screwing in/out of said nozzle in said housing results in opening/closing of said can valve, wherein the quantity of the applied contents may be controlled without a need to influence the valve by the force of a hand or without a need to pay special attention to the outflow of the content. A user of said can may pay full attention to the object or area, onto which the content is to be applied and entirely neglect attention and manual force exerted on said can. The attachment piece of the invention further comprises a cover that covers said attachment piece without a nozzle when the product is new and during discontinued application. The housing of said attachment piece is provided with an external thread intended for the positioning of a spray gun onto a can.

The essence of the invention will now be described in more detail by way of a description of an embodiment and of the enclosed drawing in which

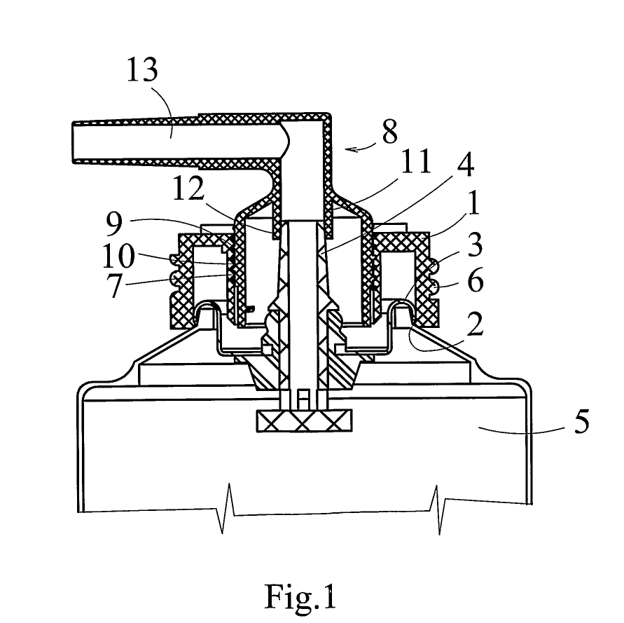

FIG. 1 shows a schematic view of the attachment piece of the invention, positioned on a spray can, in longitudinal cross-section.

The attachment piece for controlled and directed emptying of a spray can containing a liquid or gaseous substance, preferably an expandable insulating seal substance, consists of a housing 1, preferably of an annular shape, with a rest 2 in the form of an inner ring that snap fits the external circumference of a plug 3 with a valve 4 of a can 5. Said housing 1 comprises on its external surface a thread 6 for a spray gun not shown in FIGURES. The internal surface of said housing 1 also comprises a thread 7, on which a nozzle 8 is arranged. The same thread is also used for a cover not shown in FIGURES. Said cover may also be intended as a seal cover.

Said nozzle 8 is designed in a way to co-operate with said thread 7 with its thread section 9 of a cylindrical part 10. Said cylindrical part 10 continues on one side by a concentrically arranged tubular part 11 provided at the end located inside said cylindrical part 10, with said rest 12 tightly fitting the free end of said valve 4 of said can 5. On the opposite, i.e. external end, said nozzle 8 is optionally shaped, preferably in the sense of an outflow section 13 oriented perpendicularly to the axis of said can 5.

Said attachment piece is mechanically arranged on said can 5 during production of said can, so that it snap fits the external circumference of said plug 3 with its rest 2.

Prior to use of said can 5 its cover is removed and said nozzle 8 is screwed into said housing 1 in a way that said nozzle 8 is spaced from said valve 4. This prevents the outflow of the content from said can when said nozzle 8 is pressed. As a user wants the content from said can to flow from said can in a controlled and directed way, he holds said nozzle 8 with one hand and directs it to a place to be applied with the content, whereas he screws said can 5 to said nozzle 8 with the other hand. Said rest 12 tightly fits said valve 4. When said can 5 is further screwed against said nozzle 8, the latter controls the opening of said valve 4 and only such quantity of the content as desired by the user is applied. By unscrewing said nozzle 8 from said can 5 said valve 4 closes, which makes said can with said attachment piece ready for a next application. If said nozzle 8 is to be reused, it needs to be cleaned after each use with a cleaning agent suitable for the cleaning of the content of said can.

The attachment piece of the invention is made of thermoplastic materials by spray moulding. The material of the attachment piece should be selected with respect to chemical properties of the content of a can. Said attachment piece may be reusable, since it can be detached from the can, wherein the can valve automatically closes or remains closed without any danger for the process to cause inadvertent flowing out of the content.

It can be understood that a man skilled in the art may design other embodiments of the device not disclosed in the above description without circumventing the scope of the characteristics of the invention defined in the appended claims.

1. Attachment piece for controlled and directed emptying of a spray can (5) containing a liquid or gaseous substance, preferably an expandable insulating seal substance, characterised in that it consists of a housing (1) with a rest (2) in the form of an inner ring intended to be arranged onto the external circumference of a plug (3) with a valve (4) of a can (5), further of an external thread (6) for a spray gun and of an inner thread (7), on which a nozzle (8) is arranged, wherein said nozzle (8) is designed in a way to co-operate with said thread (7) with its thread section (9) of its cylindrical part (10), and in that said cylindrical part (10) is formed by a concentrically arranged tubular part (11) provided at the end located inside said cylindrical part (10), with said rest (12) tightly fitting the free end of said valve (4) of said can (5), wherein on the opposite, i.e. external end, said nozzle (8) is optionally shaped, preferably in the sense of an outflow section (13) oriented perpendicularly to the axis of said can (5).
